(19) United States
(12) Patent Application Publication
(10) Pub. No.: US 2011/0039069 A1
(43) Pub. Date: Feb. 17, 2011

(54) SELF-ADHESIVE FILM

(75) Inventors: Takashi Igawa, Inuyama-shi (JP); Shinichi Ohno, Inuyama-shi (JP); Akira Matsuda, Inuyama-shi (JP); Tohru Imai, Inuyama-shi (JP); Tadashi Nishi, Inuyama-shi (JP)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: TOYO BOSEKI KABUSHIKI KAISHA, Osaka-shi (JP)

(21) Appl. No.: 12/990,114

(22) PCT Filed: Mar. 27, 2009
(86) PCT No.: PCT/JP2009/056257

§ 371 Date: Oct. 28, 2010

(30) Foreign Application Priority Data
Apr. 30, 2008 (JP) 2008-118563

(51) Int. Cl. C09J 7/02; B32B 27/32; B32B 7/02

(52) U.S. Cl. 428/141

(57) ABSTRACT

The present invention provides a self-adhesive film which is a drawn polypropylene-based resin film comprising a laminated body containing an adhesive layer and a release layer which are provided on the surface of a base layer formed of a polypropylene-based resin, wherein an average surface roughness SRa of a surface of the above-described release layer is 0.200 μm or less, an average surface layer roughness SRa of a surface of the self-adhesive layer of the film is 0.030 μm or less, the contact area with the adherent, which is defined in the description, is 90% or more and 100% or less, and the film haze ranges from 1 to 40%. The self-adhesive film of the present invention is less likely to cause a blocking after the film is stored in a rolled state, and the processing suitability is excellent, and forming is less likely occur even when the film having been adhered to an adherend is processed at a high temperature, and further transparency is excellent.

### TECHNICAL FIELD

The present invention relates to a self-adhesive film. A self-adhesive film of the present invention is, in particular, preferably usable as a surface protection film for protecting, from undesirable influences such as adhesion of dust and scratches, the surfaces of products such as synthetic resin plates, decorated plywoods, metal plates, and coated steel plates by adhering the film to the surfaces of the products, and as a surface protection film used in dip soldering for printed-circuit boards. In the present invention, the term “self-adhesive film” also refers to a self-adhesive sheet and a self-adhesive tape.

### BACKGROUND ART

Conventionally, a self-adhesive film for protecting surfaces of objects to be covered is used when construction materials, electric products, electronic products, automobiles, and the like are processed, stored, and transported, and such the self-adhesive film needs to have a desired adhesiveness, and needs to be easily peeled, after used, without soiling the surfaces with its adhesive agent. In recent years, a self-adhesive film containing a polyolefin-based resin as a base material is used instead of a self-adhesive film containing a plasticized vinyl chloride resin as a base material. As such a self-adhesive film containing a polyolefin-based resin as a base material, a self-adhesive film which is formed by a low crystallinity adhesive layer or an amorphous adhesive layer made of EVA, a low density polyethylene, or the like, or an adhesive layer of an elastomer made of SIS, SEBS, or the like being integrated, through co-extrusion, with a base layer, is mainly used. However, the self-adhesive film described above is likely to be influenced by an environment in which an object covered with the self-adhesive film is placed. The self-adhesive film undergoes extreme changes over time especially under a high temperature environment, and therefore adhesion is increased, so that problems arise that peeling of the self-adhesive film from an adherend becomes difficult, or an adhesive agent remains unremoved.

In order to overcome the problems, a composition containing an amorphous olefin polymer and a specific ethylene-based polymer is disclosed as an adhesive agent which enables a desired adhesiveness to be maintained without causing extreme change over time even in a low temperature environment or a high temperature environment regardless of a range of used temperatures (for example, see Patent Documents 1, 2, and 3).

### Patent Document 1: Japanese Unexamined Patent Publication (JP-A) No. 2006-63123

### Patent Document 2: Japanese Unexamined Patent Publication (JP-A) No. 2006-299060

### Patent Document 3: Japanese Unexamined Patent Publication (JP-A) No. 2006-257191

However, the self-adhesive film as described above also has a problem that blocking occurs during storage.

Further, a film is disclosed which includes a surface layer having a specific surface roughness on a surface side opposite to an adhesive layer side to improve blocking resistance (for example, see Reference Document 4).

### Patent Document 4: Japanese Laid-Open Patent Publication No. 2008-68564

However, this film is also insufficient in performance.

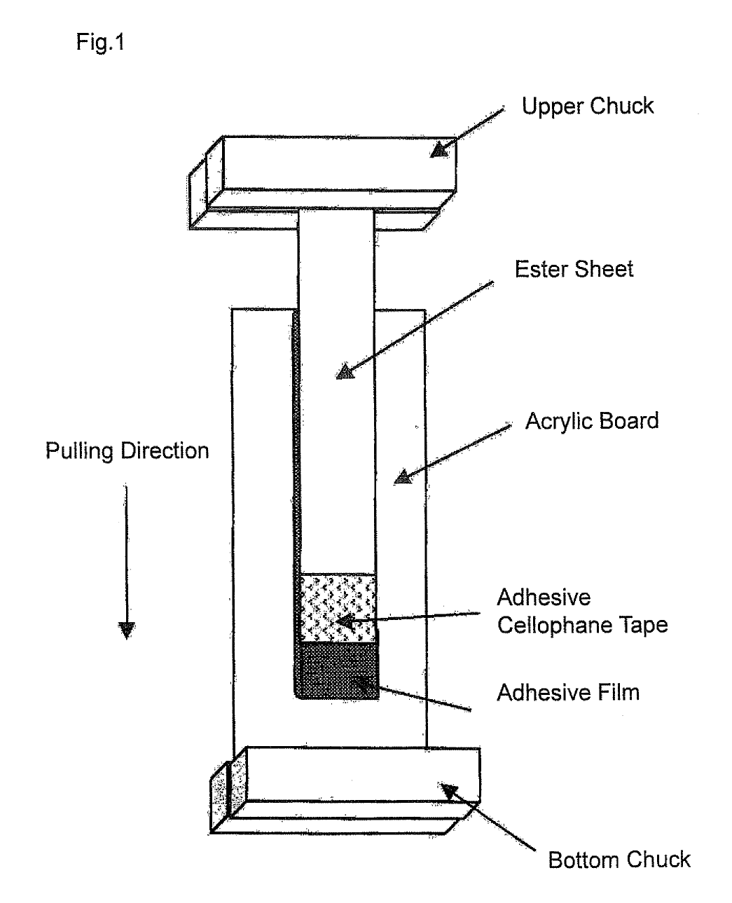

### BRIEF DESCRIPTION OF THE DRAWING

[FIG. 1] A schematic diagram illustrating a measurement sample.

### DISCLOSURE OF THE INVENTION

### Problem to be Solved by the Present Invention

In order to overcome the problems, an object of the present invention is to provide a self-adhesive film which is less likely to cause blocking between self-adhesive films, and is less likely to cause blocking particularly after the self-adhesive film is stored in a rolled state, which have excellent processing suitability, which is less likely to foam even when the self-adhesive film having been adhered to an adherend is processed at a high temperature, and which has an excellent transparency.

### Means for Solving the Problems

The inventors of the present invention found, as a result of thorough research and study, that, when self-adhesive films were put one on the other, the surface of the side on which an adhesive layer was provided was likely to be influenced by the surface of the side opposite thereto, and thus adhesion was reduced, and small foams were generated between the film and an adherend when the film was adhered to the adherend, and, in order to overcome the problems described above, the present invention was attained.

Specifically, the present invention provides a self-adhesive film which is a polypropylene-based resin film formed as a laminated body comprises an adhesive layer laminated on one surface of a base layer formed of a polypropylene-based resin, and a release layer laminated on the opposite surface of the base layer, wherein an average surface roughness SRa of a surface of the release layer is 0.200 μm or less, an average surface roughness SRa of a surface of the adhesive layer is 0.030 μm or less, a contact area contacting with an adherend as defined in the description is 90% or more and 100% or less, a haze of the film ranges from 1% to 40%.

According to the present invention, the self-adhesive film is provided which has the features that: blocking between the self-adhesive films is less likely to occur, and the blocking is less likely to occur particularly after the self-adhesive film is stored in a rolled state; the processing suitability is excellent; foaming is less likely to occur even when the film having been adhered to an adherend is processed at a high temperature; the self-adhesive film has excellent transparency. Therefore, according to the present invention, the self-adhesive film is obtained which is not influenced by a storage state, and there is little change of the adhesion over time.

Further, tackiness is excellent, and processing suitability is excellent.

Further, in this case, the adhesive layer preferably contains a polypropylene-based elastomer.

Moreover, in this case, it is preferable that the polypropylene-based elastomer is one of an amorphous polypropylene which consists of only a polypropylene-based resin, or a copolymer of polypropylene and an ethylene-propylene rubber.

Furthermore, in this case, the surface of the release layer preferably has the average surface roughness SRa of less than or equal to 0.150 μm.

In addition, in this case, the surface of the adhesive layer preferably has the average surface roughness SRa of less than or equal to 0.020 μm.

Further, in this case, it is preferable that the base layer, the adhesive layer, and the release layer are formed by melt extruded raw materials from a plurality of extruders and then laminated in a co-extrusion method.

Furthermore, in this case, it is preferable that the self-adhesive film is formed as a film roll, and the film roll has a width of greater than or equal to 450 mm, and a length of greater than or equal to 300 m.

### EFFECT OF THE PRESENT INVENTION

The self-adhesive film of the present invention has advantages that: blocking between the self-adhesive films is less likely to occur, and the blocking is less likely to occur particularly after the self-adhesive film is stored in a rolled state; the processing suitability is excellent; foaming is less likely to occur even when the film having been adhered to an adherend is processed at a high temperature; and transparency is excellent.

### BEST MODE FOR CARRYING OUT THE INVENTION

Hereinafter, an embodiment of a self-adhesive film according to the present invention will be described.

### (Base Layer)

A self-adhesive film of the present invention needs to have a base layer formed of a polypropylene-based resin. Examples of the polypropylene-based resin to be employed in the present invention include a crystalline polypropylene resin, and a random copolymer or a block copolymer which is formed by propylene and a small amount of α-olefin. More specifically, examples of the crystalline polypropylene resin include an isotactic propylene homopolymer which is insoluble in n-heptane and a copolymer of polypropylene containing 60% by weight or more of propylene and another α-olefin, both of which are used in a typical extrusion molding. The propylene homopolymer or the copolymer of propylene and another α-olefin may be used independently used or in combination thereof.

The “n-heptane-insoluble” represents an index of crystallinity of polypropylene and also represents an index of safety. In the present invention, n-heptane insolubility which complies with Notification of the Japanese Ministry of Health and Welfare No. 20 of February, 1982 (eluted amount obtained when extraction is performed at 25° C. for 60 minutes is less than or equal to 150 PPm [and is less than or equal to 30 pPm when the used temperature is higher than 100° C.]) is preferably used.

Preferred examples of an α-olefin copolymerization component for the copolymer of propylene and another α-olefin include an α-olefin containing 2 to 8 carbon atoms, for example, ethylene, and a C4 or higher α-olefin such as 1-butene, 1-pentene, 1-hexene, and 4-methyl-1-pentene.

The copolymer is preferably a random or a block copolymer which is obtained by polymerization of propylene and one kind of α-olefin or two or more kinds of α-olefins as exemplified above.

Further, the melt flow rate (MFR) of the copolymer may range from 0.1 g/10 min. to 100 g/10 min., and preferably ranges from 0.5 g/10 min. to 20 g/10 min., and more preferably ranges from 1.0 g/10 min. to 10 g/10 min., for example. Particularly, the melt flow rate preferably ranges from 2.0 g/10 min. to 7.0 g/10 min.

Two or more kinds of the copolymers of propylene and another α-olefin may be used in combination thereof. A propylene-1-butene copolymer is preferably used since stiffness of the film becomes low and the film has an improved tackiness, thereby enhancing a ratio of contact area.

### (Adhesive Layer)

Since an adhesive layer is provided on one surface of the base layer formed of a polypropylene-based resin, an olefin-based polymer is preferably used as a resin for an adhesive layer of the present invention. Thus, a strength between the layers can be increased, and the adhesive layer is prevented from remaining unremoved from an adherend after peeling.

Further, the adhesive layer preferably contains a polyolefin-based elastomer to satisfy the area contacting ratio of the self-adhesive film with an adherend required in the present invention.

A resin indicated in the following (1) or (2) is preferably used in a method for obtaining the adhesive layer containing the polyolefin-based elastomer.

(1) A resin containing: a polymerized type thermoplastic elastomer obtained by dispersing a small amount of an olefin-based rubber in a matrix of a polypropylene resin; and another thermoplastic elastomer.

For example, “ZELAS MC707” and “ZELAS MC717” (“ZELAS” is registered trademark) manufactured by Mitsubishi Chemical Corporation can be exemplified.

(2) A resin containing: an amorphous polypropylene resin consisting of only a polypropylene-based resin, and a resin exemplified below which is mixed in an amount of 15% by weight or more and 30% by weight or less, per the total weight of a resin constituting the adhesive layer.

A polymer which is selected from among an ethylene-propylene copolymer, an ethylene-1-butene copolymer, an ethylene-1-hexene copolymer, an ethylene-1-octene copolymer, an ethylene-4-methyl-1-pentene copolymer, an ethylene-propylene-1-butene copolymer, an ethylene-propylene-1-hexene copolymer, an ethylene-1-butene-1-hexene copolymer, a propylene-1-butene copolymer, a propylene-1-hexene copolymer, a propylene-1-octene copolymer, a propylene-4-methyl-1-pentene copolymer, a propylene-1-butene-1-hexene copolymer, or a propylene-1-butene-4-methyl-1-pentene copolymer, and which has an elastic modulus of less than or equal to 600 MPa as defined by JIS K 7162 (specimen: Type 1A, chuck clearance: 115 mm, speed: 1 mm/min.).

Further, the melt flow rate of the polymer mixed with the amorphous polypropylene resin preferably ranges from 1 g/10 min. to 10 g/10 min.

As the amorphous polypropylene resin consisting of only a polypropylene-based resin, an amorphous polypropylene resin which has a crystalline melting heat value and a crystallization heat value each determined as being less than or equal to 40 J/g in the differential scanning calorimetry is most preferable.

At this time, a polypropylene resin having a crystalline melting heat value and a crystallization heat value each determined as being greater than or equal to 10 J/g is more suitable.

Examples of the amorphous polypropylene resin consisting of only a polypropylene-based resin include “TAFTHREN H3522A” manufactured by Sumitomo Chemical Co., Ltd. (“TAFTHREN” is registered trademark), and “NOTIO PN3560” manufactured by Mitsui Chemicals, Inc (“NOTIO” is registered trademark).

“TAFTHREN H3522A” manufactured by Sumitomo Chemical Co., Ltd. is an amorphous polypropylene resin formed of a mixture of a completely amorphous polypropylene resin and a crystalline polypropylene resin, and the content of the completely amorphous polypropylene resin in the adhesive layer is preferably 50% by weight or more.

The average surface roughness SRa of the surface of the adhesive layer of the self-adhesive film according to the present invention needs to be less than or equal to 0.030 μm. The average surface roughness SRa is preferably 0.025 μm or less, and is more preferably 0.020 μm or less, and is in particular preferably 0.015 μm or less.

When the average surface roughness SRa of the adhesive layer surface is greater than 0.030 μm, the contact area is reduced when the self-adhesive film is adhered to an adherend, and this unfavorably causes reduction of the adhesion. One of determinant factors of adhesion is an attracting force between substances, that is, the van der Waals force, which occurs on a surface with which the adhered film contacts. This force contributes to the adhesion. That the contact area is small means that the attracting force between the surface of the film adhered to an adherend and the surface of the adherend is reduced, so that the adhesion is unfavorably reduced.

Further, the surface of the adhesive layer needs to be as flat as possible, and therefore it is preferable that addition of an additive which may form an uneven surface is minimized.

On the other hand, it is substantially difficult to form the surface of the adhesive layer having the average surface roughness SRa which is less than 0.010 μm even in a drawn film containing no additive.

The self-adhesive film of the present invention is produced such that a variation of the thickness in the traverse direction which is a direction orthogonal to the wound direction in which the film is wound during film manufacturing is preferably 2.0% or more, and is 10.0% or less, and is more preferably 8.0% or less, and is even more preferably 6.0% or less. In a case where the variation of the thickness is greater than 10.0%, when the self-adhesive film is adhered to an adherend under pressure, the pressure is non-uniform among positions, which may unfavorably cause reduction of the adhesion. On the other hand, it is substantially difficult to reduce the variation of the thickness so as to be less than 2.0%.

When the characteristic of the contact surface on which the film of the present invention contacts with an adherend is measured, based on JIS-Z-0237 Testing methods of self-adhesive tapes and sheets, in the method described in the examples, an obtained area contacting ratio value is preferably 90% or more, and is more preferably 95% or more, and is in particular preferably 98% or more.

Thus, when heating treatment is conducted under a condition of non-80° C.×24 hours, foaming is less likely to occur, and the adhered film may be prevented from being raised and/or peeled from an acrylic board.

This is because increase of the contact area leads to elimination of invisible foams which exist at an interface between the film and an adherend.

At this time, a difference between an initial adhesion of the film at 50° C. and an initial adhesion of the film at 23° C. is preferably 10 cN/25 mm or less, and is in particular preferably less than 5 cN/25 mm. As described above, when a difference between the adhesion at a high temperature and the adhesion at room temperature is small, there is little change of adhesion over time.

The adhesion of the self-adhesive film of the present invention preferably ranges from 3 cN/25 mm to 50 cN/25 cm at 23° C. in view of its performance for protecting an adherend, and its peelability. The adhesion may be appropriately adjusted, as necessary, by adjusting the amounts and the composition of amorphous components of the resin of the adhesive layer.

The self-adhesive film of the present invention may contain a known additive as necessary. For example, the self-adhesive film may contain a lubricant, an anti-blocking agent, a heat stabilizer, an antioxidant, an antistatic agent, a light resistance agent, an impact modifier, and the like.

However, an amount of low molecular weight substances in the surface of the adhesive layer is preferably less than 1 mg/m².

The measurement of the low molecular weight substances in the surface of the adhesive layer was conducted in the following procedure. The surface of the adhesive layer was washed by using an organic solvent such as ethanol which does not erode a resin of the adhesive layer, and the organic solvent was then removed from the wash solution by using an evaporator or the like, and the residue was weighed, to obtain a value. The obtained value was divided by an area of the washed surface of the adhesive layer, to obtain the amount of the low molecular weight substances. When the amount of the residue is 1 mg/m² or more, foreign matters exist between the surface of the adhesive layer and the surface of an adherend, and this reduces the contact area, which may result in reduction of van der Waals force. Therefore, the adhesion is unfavorably reduced. When an additive is added, a high molecular weight additive or the like needs to be selected, or an addition method needs to be studied, so as to prevent the additive from shifting to or transferring to the adhesive layer.

### (Release Layer)

The self-adhesive film of the present invention has, on the base layer, a release layer formed on a surface side opposite to one surface side, of the base layer, on which the adhesive layer is provided. Thus, even when the self-adhesive films are piled, blocking between the self-adhesive films is reduced. In particular, the blocking is reduced even in the self-adhesive film having been stored in a rolled state. Thus, processing suitability is excellent.

In this case, the average surface roughness SRa of a surface thereof is preferably greater than or equal to 0.050 μm.

However, if the release layer is simply provided, the unevenness of the surface of the release layer is transferred to the surface of the adhesive layer, and the adhesion and/or the adhesion area as described above are reduced, and/or the adhesion obtained immediately after the self-adhesive film is adhered to an adherend is different from the adhesion measured after the elapse of time. Therefore, the average surface roughness SRa thereof is preferably less than or equal to 0.200 μm. Thus, the blocking-resistance, and the performance for protecting an adherend can be improved.

At this time, the unevenness of the surface of the release layer is formed such that the average surface roughness SRa of the surface is preferably 0.150 μm or less, and is more preferably 0.060 μm or more, and is 0.130 μm or less, and is most preferably 0.080 μm or more and is 0.130 μm or less.

In order to form the unevenness of the surface as described above, for example, a layer formed of a silicone resin or a fluororesin, or a layer which has a rough matte surface obtained by mixing a resin containing a propylene-ethylene block copolymer and a polyethylene resin may be used as a laminate.

Specific examples of the resin suitable for obtaining a matte surface include a propylene-ethylene block copolymer, such as “PC480A” and “PC523A”, manufactured by SunAllomer Ltd.

In order to increase the average roughness SRa of the release layer surface, “PC523A” manufactured by SunAllomer Ltd. is advantageous. However, when “PC523A” is independently used, the surface roughness is excessively increased.

### (Self-Adhesive Film)

Further, a haze value of the self-adhesive film of the present invention preferably ranges from 1 to 40, especially when used for adherends for optics. The haze value thereof more preferably ranges from 1% to 30%, and in particular preferably ranges from 1% to 25%.

The thickness of the adhesive layer of the present invention is preferably greater than or equal to 1 μm, and is less than 30 μm.

When the thickness of the adhesive film is less than 1 μm, a problem may arise in adhesiveness. When the thickness thereof is greater than or equal to 30 μm, a problem may arise that the adhesion of the surface of the adhesive layer is excessively increased.

At this time, in order to increase the adhesion, the thickness is preferably increased in consideration of the viscosity. When the thickness of the adhesive layer is increased, the area of contact with an adherend is likely to be increased. The effect is preferable particularly when a relatively hard resin is used for the adhesive layer.

The thickness of the adhesive layer is preferably to 2 μm or more, and 20 μm or less, and is more preferably 2 μm or more, and 15 μm or less, and is in particular preferably 2 μm or more, and 5 μm or less, in view of blocking.

The thickness of the base layer of the present invention is preferably 5 μm or more, and is less than 100 μm, and is more preferably 15 μm or more, and 25 μm or less.

When the thickness of the adhesive film is less than 5 μm, a problem arises that stiffness is insufficient, and thus crinkles are likely to occur, and the adhesion is insufficient. When the thickness thereof is greater than or equal to 100 μm, problems associated with cost arise.

A tackiness represents an instantaneous adhesion, and is used as an index indicating how easily the adhesion can be performed at an initial adhesion time.

The self-adhesive film of the present invention is preferably rolled in view of handling.

The upper limits of the width and the wound length of a film roll are not restricted to any specific values. However, the width is typically 1.5 m or less, and the wound length is preferably 6000 m or less in the case of the thickness of the film being 45 μm, in view of easy handling. Further, as a winding core, a plastic core or a metal core having a size of 3 inches, 6 inches, 8 inches or the like can be typically used.

Moreover, in view of processing suitability, the film is preferably wound as a film roll having a length of 300 m or more, and a width of 450 mm or more.

The self-adhesive film of the present invention can be suitably used particularly for: protecting surfaces of synthetic resin plates (for, for example, optical components and construction materials), stainless plates (for, for example, construction materials), aluminum plates, decorated plywoods, steel plates, glass plates, home electric appliances, and precision machinery, and the surfaces of automobile bodies being manufactured; protecting, from scratches, products which are being piled, stored, transported, and conveyed in manufacturing process; and protecting products from scratches in secondary processing (for example, in bending or pressing).

### EXAMPLES

Next, the present invention will be described in detail based on examples. However, the present invention is not limited to the examples described below, and numerous modifications can be devised without departing from the gist of the invention. The method for evaluating physical properties in examples and comparative examples described below is as follows.

(1) Crystalline Melting Heat and Crystallization Heat Value

About 5 mg of a polyolefin resin was weighed, was heated to 200° C. at a temperature increase rate of 10° C./min., was maintained at 200° C. for five minutes, and was then cooled to 0° C. at a temperature decrease rate of 10° C./min., and was heated again to 200° C. at a temperature increase rate of 10° C./min. to a chart by using the differential scanning calorimeter (DSC-60) manufactured by SHIMADZU CORPORATION, and the crystalline meting heat and the crystallization heat value were found from the obtained chart.

(2) Elastic Modulus of Resin

The elastic modulus of a resin was measured according to JIS K 7162 determination method under the following conditions.

### Specimen: Type 1A

Chuck clearance: 115 mm
Speed: 1 ram/min.

(3) Measurement of Surface Roughness

The center plane average surface roughness (SRa) of each of the release layer surface and the adhesive layer surface was measured by using the contact-type three-dimensional center surface roughness measuring device (Type ET-30HK) and the three-dimensional roughness analyzer (SPA-11) each manufactured by Kosaka Laboratory Ltd., in a method using a sensing probe, under the following conditions.

The conditions were as follows. An average of values obtained in 20 measurements was calculated as the value of the surface roughness.

Sensing probe tip radius: 0.5 μm
Sensing probe pressure: 20 mg
Cutoff value: 80 μm
Measured length: 1000 μm
Vertical magnification: ×5000
Measurement speed: 100 μm/s
Measurement interval: 2 μm

(4) Evaluation of Adhesion

The adhesion was measured, based on JIS-Z-0237 (2000) testing methods of self-adhesive tapes and sheets, in the following method.

An acrylic board of 50 mm×150 mm (manufactured by MITSUBISHI RAYON CO., LTD.: ACRYLITE 3 mm thickness, “ACRYLITE” is a registered trademark) was prepared as an adherend, and a film was cut into a specimen having a size of 25 mm in the wound direction in which the film was wound during film manufacturing, and 180 mm in the direction orthogonal thereto, and a rubber roll (a roller surface spring hardness of 80 Hs, the rubber roll had a rubber layer having the thickness of 6 mm covering the roller, and had a width of 45 mm and a diameter of 95 mm (including the rubber layer)) having a mass of 2000 g was reciprocated once on the adherend and the specimen at a speed of 5 mm/second to pressure-adhere the specimen to the adherend. The specimen which was left for 30 minutes after the pressure-adhesion, in an environment in which a temperature was 23° C. and a relative humidity was 65%, was used as an initial stage specimen, and the specimen which was left for 24 hours after the pressure-adhesion, in an environment in which a temperature was 23° C. and a relative humidity was 65%, was used as a specimen changing over time. The initial stage specimen and the specimen changing over time were peeled from the adherends, respectively, at a speed of 300 mm/min. at an angle of 180 degrees by using the “TENSILON” (UTM-IIIL) manufactured by Toyo Seiki. Resistance values obtained at this time were used as the adhesions [cN/25 mm]. The peeling at 180 degrees indicates that an angle at which the film is peeled from the acrylic board is maintained as 180 degrees when the resistance value at the peeling is measured.

A polyester sheet having a thickness of 190 μm and a size of 25 mm×170 mm was prepared as a chuck margin for allowing the measurement sample to be chucked when the measurement was performed. The polyester sheet was attached to the end of the self-adhesive film side of the measurement sample including the acrylic board and the self-adhesive film which was pressure-adhered to the acrylic board, by using an adhesive cellophane tape, with an attachment margin having a width of 15 mm, so as to be used as a chuck margin for measurement. FIG. 1 is a schematic diagram illustrating the measurement sample. The measurement was conducted three times for one sample, and the average of the obtained results was calculated as the adhesion of the sample.

(5) Evaluation of Area Contacting Ratio of Area Contacting with Adherend

The self-adhesive film was adhered to the acrylic board in the same manner as that for (4), and was left at 23° C. After 30 minutes elapsed in this state, a state of the contact surface between the acrylic board and the self-adhesive film was observed.

Condition for observation: The digital microscope VHX-200F manufactured by Keyence Corporation was used. A digital image was taken at ×100 magnification, and a ratio of an area of a part of the self-adhesive film contacting with the acrylic board to the area of the self-adhesive film specimen was calculated by using image analysis software.

(6) Foaming in High Temperature Treatment

The self-adhesive film was adhered to the acrylic board in the same manner as that for (4), and was subjected to heating treatment at 80° C. for 24 hours. Whether or not the adhered film was raised from the acrylic board and/or whether or not the adhered film was peeled from the acrylic board were visually checked, to evaluate whether or not foaming occurred in the high temperature treatment.

∘: Neither raising nor peeling caused by foaming was observed.
x: Occurrence of foaming was observed.

(7) Film Haze

The film haze was measured based on JIS-K-7105 testing methods for optical properties of plastics by using the haze meter NDH-2000 manufactured by NIPPON DENSHOKU INDUSTRIES CO., LTD.

(8) Evaluation of Blocking Resistance

The self-adhesive films were each cut into a size of a length 150 mm×a width 50 mm, and the self-adhesive films were superimposed one on the other such that the adhesive layer surface was opposed to the release layer surface. Thereafter, the self-adhesive films superimposed one on the other were left under a load of 20 kg at 40° C. for seven days. After that, the self-adhesive films having been processed were cut into a size of a width 25 mm×a length 100 mm, and a resistance value [cN/25 mm] was measured by using the tensile tester, TENSILON UT-IIIL, manufactured by Toyo Seiki, when the adhesive layer surface and the release layer surface were separated from each other at 180 degrees at a speed of 300 mm/min.

(9) Thickness Variation

The thickness variation was measured by using Anritsu FILM THICKNESS TESTERS KG601A and K306C in the following method.

Measurement speed: 0.01 second
Feeding speed: 1.5 m/min.

### HIGH CUTOFF

Sampling process: OFF

The films were each cut into a sample having a size of 40 mm in the wound direction in which the film was wound during film manufacturing, and a length of 500 mm in the direction orthogonal to the wound direction. The thickness in the direction orthogonal to the wound direction was measured continuously under the conditions described above. The thickness variation was calculated, based on the result obtained by the measurement, by using the following equation (2). The measurement was conducted five times for one sample, and the average of results of the five measurements was obtained as the thickness variation of the sample.

Thickness variation(%)=[(maximum thickness value−minimum thickness value)/the average of the thickness values]×100 (2)

### Example 1

### Production of Base Layer

By employing a uniaxial extruder (L/D: 22.4) having-60 mmφ, 100 weight % of a homo polypropylene resin (manufactured by Sumitomo Chemical Co., Ltd.: FLX80E4, tensile modulus: 1500 MPa) was melted and extruded to obtain a base layer.

### Production of Adhesive Layer

By using a biaxial extruder (L/D: 19) having 45 mmφ, 100 weight % of an olefin-based elastomer (manufactured by Mitsubishi Chemical Corporation: ZELAS MC707) was melted and extruded to obtain an adhesive layer.

### Production of Release Layer

By using a uniaxial extruder (L/D: 25) having 65 mmφ, 100 weight % of a propylene-ethylene block copolymer (manufactured by SunAllomer Ltd.: PC480A) was melted and extruded to obtain a release layer.

### Production of Film

In a state where the base layer, the adhesive layer, and the release layer were melted in the extruders, respectively, the base layer, the adhesive layer, and the release layer were laminated and extruded by using a three-layer T die (multi-manifold type, lip width was 250 mm, and lip gap was 1 mm) under a temperature of 250° C. The extruded film was applied to a casting roll having a temperature of 20° C. by using an air knife, and was taken up at a speed of 12 m/min., cooled, and solidified, to obtain a three-kind three-layer undrawn film having a base layer having a thickness of 40 μm, an adhesive layer having a thickness of 5 μm, and a release layer having a thickness of 5 μm.

The result of evaluation of the characteristics of the film indicated that: a smooth adhesive layer was formed; the adhesion was obtained at room temperature; non-uniform contact between an adherend and the adhesive layer was not observed; no foaming occurred when high temperature treatment was conducted after adhesion to the adherend; an appearance was excellent; no blocking occurred between the release layer and the adhesive layer; and handling was preferable.

### Example 2

A three-kind three-layer undrawn film was obtained by the same production method as used in example 1 such that the base layer and the release layer were the same as those for example 1, and the adhesive layer and the thickness ratios of each layer were changed as described below.

### Adhesive Layer

An amorphous PP (manufactured by Sumitomo Chemical Co., Ltd.: TAFTHREN H3522A, crystalline melting heat value and a crystallization heat value: 28 J/g (respectively)) and a homo polypropylene resin (manufactured by Sumitomo Chemical Co., Ltd.: FLX80E4, tensile modulus: 1500 MPa) were blended in a blending ratio of 80/20 wt % (amorphous PP/homo polypropylene), the obtained mixture was melted and extruded by using a biaxial extruder (L/D: 19) having 45 mmφ, to obtain an adhesive layer.

### Production of Film

In a state where the base layer, the adhesive layer, and the release layer were melted in the extruders, respectively, the base layer, the adhesive layer, and the release layer were laminated and extruded by using a three-layer T die (multi-manifold type, lip width was 250 mm, and lip gap was 1 mm) under a temperature of 250° C. The extruded film was applied to a casting roll having a temperature of 20° C. by using an air knife, and was taken up at a speed of 12 m/min., cooled, and solidified, to obtain a three-kind three-layer undrawn film having a base layer having a thickness of 25 μm, an adhesive layer having a thickness of 20 μm, and a release layer having a thickness of 5 μm.

The result of evaluation of the characteristics of the film indicated that: a smooth adhesive layer was formed; the adhesion was obtained at room temperature; non-uniform contact between an adherend and the adhesive layer was not observed; no foaming occurred when high temperature treatment was conducted after adhesion to the adherend; an appearance was excellent; no blocking occurred between the release layer and the adhesive layer; and handling was preferable.

### Example 3

A three-kind three-layer undrawn film was obtained by the same production method as used in example 1 such that the base layer and the release layer were the same as those for example 1, and the adhesive layer and the thickness ratios of each layer were changed as described below.

### Adhesive Layer

An amorphous PP (manufactured by Sumitomo Chemical Co., Ltd.: TAFTHREN H3522A, crystalline melting heat value and a crystallization heat value: 28 J/g (respectively)) and a propylene-1-butene copolymer (manufactured by Sumitomo Chemical Co., Ltd.: SPX78J1, tensile modulus: 530 MPa) were blended in a blending ratio of 80/20 wt % (amorphous PP/propylene-1-butene copolymer), the obtained mixture was melted and extruded by using a biaxial extruder (L/D: 19) having 45 mmφ, to obtain an adhesive layer.

### Production of Film

In a state where the base layer, the adhesive layer, and the release layer were melted in the extruders, respectively, the base layer, the adhesive layer, and the release layer were laminated and extruded by using a three-layer T die (multi-manifold type, lip width was 250 mm, and lip gap was 1 mm) under a temperature of 250° C. The extruded film was applied to a casting roll having a temperature of 20° C. by using an air knife, and was taken up at a speed of 12 m/min., cooled, and solidified, to obtain a three-kind three-layer undrawn film having a base layer having a thickness of 35 μm, an adhesive layer having a thickness of 10 μm, and a release layer having a thickness of 5 μm.

The result of evaluation of the characteristics of the film indicated that: a smooth adhesive layer was formed; the adhesion was obtained at room temperature; non-uniform contact between an adherend and the adhesive layer was not observed; no foaming occurred when high temperature treatment was conducted after adhesion to the adherend; an appearance was excellent; no blocking occurred between the release layer and the adhesive layer; and handling was preferable.

### Example 4

A three-kind three-layer undrawn film was obtained by the same production method as used in example 1 such that the base layer and the release layer were the same as those for example 1, and a resin employed for the base layer was changed as described below.

### Base Layer

By employing a uniaxial extruder (L/D: 19) having 45 mmφ, a propylene-1-butene copolymer (manufactured by Sumitomo Chemical Co., Ltd.: SPX78J1, tensile modulus: 530 MPa) was melted and extruded to obtain an adhesive layer.

### Comparative Example 1

### Production of Base Layer

By employing a uniaxial extruder (L/D: 22.4) having 60 mmφ, 100 weight % of a homo polypropylene resin (manufactured by Sumitomo Chemical Co., Ltd.: FLX80E4) was melted and extruded to obtain a base layer.

### Production of Adhesive Layer

An amorphous PP (manufactured by Sumitomo Chemical Co., Ltd.: TAFTHREN H3522A) and a homo polypropylene resin (manufactured by Sumitomo Chemical Co., Ltd.: FLX80E4) were blended in a blending ratio of 80/20 wt % (amorphous PP/homo polypropylene), the obtained mixture was melted and extruded by using a biaxial extruder (L/D: 19) having 45 mmφ, to obtain an adhesive layer.

### Production of Release Layer

By using a uniaxial extruder (L/D: 25) having 65 mmφ, 100 weight % of a propylene-ethylene block copolymer (manufactured by SunAllomer Ltd.: PC480A) was melted and extruded to obtain a release layer.

### Production of Film

In a state where the base layer, the adhesive layer, and the release layer were melted in the extruders, respectively, the base layer, the adhesive layer, and the release layer were laminated and extruded by using a three-layer T die (multi-manifold type, lip width was 250 mm, and lip gap was 1 mm) under a temperature of 250° C. The extruded film was applied to a casting roll having a temperature of 20° C. by using an air knife, and was taken up at a speed of 12 m/min., cooled, and solidified, to obtain a three-kind three-layer undrawn film having a base layer having a thickness of 40 μm, an adhesive layer having a thickness of 5 μm, and a release layer having a thickness of 5 μm.

The result of evaluation of the characteristics of the film indicated that: a smooth adhesive layer was formed; the adhesion was obtained at room temperature. However, non-uniform contact between an adherend and the adhesive layer was observed, and a contact area between the adherend and the adhesive surface was small. Further, Further, foaming occurred when high temperature treatment was conducted after the adhesion, and an appearance thereof was deteriorated after heating treatment. No blocking occurred between the release layer and the adhesive layer, and handling was preferable.

### Comparative Example 2

A three-kind three-layer undrawn film was obtained by the same production method as used in example 1 such that the base layer and the adhesive layer were the same as those for example 1, and the release layer and the composition of each layer were changed as indicated below.

### Production of Release Layer

By using a uniaxial extruder (L/D: 25) having 65 mmφ, 100 weight % of a propylene-ethylene block copolymer (manufactured by SunAllomer Ltd.: PC523A) was melted and extruded to obtain a release layer.

### Production of Film

In a state where the base layer, the adhesive layer, and the release layer were melted in the extruders, respectively, the base layer, the adhesive layer, and the release layer were laminated and extruded by using a three-layer T die (multi-manifold type, lip width was 250 mm, and lip gap was 1 mm) under a temperature of 250° C. The extruded film was applied to a casting roll having a temperature of 20° C. by using an air knife, and was taken up at a speed of 12 m/min., cooled, and solidified, to obtain a three-kind three-layer undrawn film having a base layer having a thickness of 40 μm, an adhesive layer having a thickness of 5 μm, and a release layer having a thickness of 5 μm.

The result of evaluation of the characteristics of the film indicated that: adhesion thereof was slightly reduced at room temperature; the surface of the adhesive layer had a high roughness; non-uniform contact between an adherend and the adhesive layer was observed; and a contact area between the adherend and the adhesive surface was small. Further, foaming occurred when high temperature treatment was conducted after the adhesion, and an appearance thereof was deteriorated after heating treatment. No blocking occurred between the release layer and the adhesive layer, and handling was preferable.

### Comparative Example 3

A three-kind three-layer undrawn film having a base layer thickness of 40 μm, an adhesive layer thickness of 5 μm and a release layer thickness of 5 μm was obtained by the same production method as used in example 1 such that the base layer and the adhesive layer were the same as those for example 1, and the release layer was changed as described below.

### Release Layer

By using a uniaxial extruder (L/D: 25) having 65 mmφ, 100 weight-% of a homo propylene resin (manufactured by Sumitomo Chemical Co., Ltd.: FLX80E4) was melted and extruded to obtain a release layer.

The result of evaluation of the characteristics of the film indicated that: a smooth adhesive layer was formed; the adhesion was obtained at room temperature; non-uniform contact between an adherend and the adhesive layer was not observed; and a contact area between the adherend and the adhesive surface was sufficient. Further, no foaming occurred when high temperature treatment was conducted after the adhesion, and an appearance thereof was preferable after heating treatment. However, strong blocking occurred between the release layer and the adhesive layer, and there was a problem in handling.

The results are summarized in table 1.

TABLE 1

| | Example | Example | Example | Example | Comparative | Comparative | Comparative |
|---|---|---|---|---|---|---|---|
| x | 1 | 2 | 3 | 4 | Example 1 | Example 2 | Example 3 |
| Release layer | PC480A | PC480A | PC480A | PC480A | PC480A | PC523A | FLS80E4 |
| resin | 100 (wt %) | 100 (wt %) | 100 (wt %) | 100 (wt %) | 100 (wt %) | 100 (wt %) | 100 (wt %) |
| Base layer | FLX80E4 | FLX80E4 | FLX80E4 | SPX78EJ1 | FLX80E4 | FLX80E4 | FLX80E4 |
| resin | 100 (wt %) | 100 (wt %) | 100 (wt %) | 100 (wt %) | 100 (wt %) | 100 (wt %) | 100 (wt %) |
| Adhesive layer | MC707 | H3522S/FLX80E4 = | H3522S/SPX78J1 = | MC707 | H3522S/FLX80E4 = | MC707 | MC707 |
| resin | 100 (wt %) | 80/20 (wt %) | 80/20 (wt %) | 100 (wt %) | 80/20 (wt %) | 100 (wt %) | 100 (wt %) |
| Total film | 50 | 50 | 50 | 50 | 50 | 50 | 50 |
| thickness (μm) | | | | | | | |
| Release layer | 5 | 5 | 5 | 5 | 5 | 5 | 5 |
| thickness (μm) | | | | | | | |
| Base layer | 40 | 25 | 35 | 40 | 40 | 40 | 40 |
| thickness (μm) | | | | | | | |
| Adhesive layer | 5 | 20 | 10 | 5 | 5 | 5 | 5 |
| thickness (μm) | | | | | | | |
| Center surface | 0.12 | 0.12 | 0.12 | 0.12 | 0.12 | 0.55 | 0.03 |
| average roughness | | | | | | | |
| SRa/Release layer | | | | | | | |
| Center surface | 0.012 | 0.015 | 0.02 | 0.012 | 0.015 | 0.03 | 0.01 |
| average roughness | | | | | | | |
| SRa/Adhesive layer | | | | | | | |
| Film haze | 13 | 13 | 13 | 13 | 13 | 60 | 13 |
| Adhesion (cN/25 mm)/ | 15 | 20 | 40 | 15 | 20 | 10 | 25 |
| initial | | | | | | | |
| Adhesion (cN/25 mm)/ | 15 | 80 | 150 | 15 | | 13 | 25 |
| over time | | | | | | | |
| Blocking resistance | 5 | 7 | 5 | 5 | 5 | 5 | 60 |
| Ratio of contacting | 100 | 92 | 97 | 98 | 30 | 87 | 97 |
| area of adherend/ | | | | | | | |
| adhesive layer | | | | | | | |
| Foaming in high | ◯ | ◯ | ◯ | ◯ | X | Δ | ◯ |
| temperature treatment | | | | | | | |

### INDUSTRIAL APPLICABILITY

The self-adhesive film according to the present invention is less likely to cause a blocking between the self-adhesive films, and the blocking is less likely to occur particularly after the self-adhesive film is stored in a rolled state, and the processing suitability is excellent, and foaming is less likely to occur even when the film having been adhered to an adherend is processed at a high temperature. Therefore, the self-adhesive film can be used for various purposes and in various fields, such as for synthetic resin plates, decorated plywoods, metal plates, and coated steel plates, and further for bake-coating for automobiles, and for printed circuit boards, and therefore can substantially contribute to industries.

1. A self-adhesive film comprising
(a) a base layer, which comprises a polypropylene-based resin,
(b) an adhesive layer laminated on one surface of the base layer, and
(c) a release layer laminated on an opposite surface of the base layer,
wherein
an average surface roughness SRa of a surface of the release layer is 0.200 μm or less,
an average surface roughness SRa of a surface of the adhesive layer is 0.030 μm or less,
an area contacting ratio of a part of the self-adhesive film contacting with an adherend to the self-adhesive film area is 90% or more, and 100% or less, which area contacting ratio is obtained by adhering the self-adhesive film to an acrylic board as adherend, and being left at 23° C. for 30 minutes, in accordance with JIS-Z-0237 (2000) testing methods of self-adhesive tapes and sheets, and then photographing a part of the self-adhesive film contacting with the acrylic board at 100-fold magnification using a digital microscope, followed by calculating the area contacting ratio by using image analysis software, and
a haze of the film ranges from 1% to 40%.

2. The self-adhesive film according to claim 1, wherein the adhesive layer comprises a polyolefin-based elastomer.

3. The self-adhesive film according to claim 2, wherein the polyolefin-based elastomer is an amorphous polypropylene consisting of only a polypropylene resin or a copolymer of polypropylene and an ethylene-propylene rubber.

4. The self-adhesive film according to claim 1, the average surface roughness SRa of the release layer is 0.050 μm or more and 0.150 μm or less.

5. The self-adhesive film according to claim 1, wherein the average surface roughness SRa of the adhesive layer is 0.010 μm or more and 0.020 μm or less.

6. The self-adhesive film according to claim 1, wherein the base layer, the adhesive layer, and the release layer are prepared by melting and extruding resins constituting each layer using a plurality of extruders, and then laminating the layers in a co-extrusion method.

7. (canceled)

8. The self-adhesive film according to claim 1, wherein the self-adhesive layer contains an amorphous polypropylene resin and a propylene-1-buten copolymer or a homopolypropylene resin.

9. The self-adhesive film according to claim 8, the self adhesive layer contains an amorphous polypropylene resin and a propylene-1-butene copolymer or a homopolypropylene resin, and the adhesive layer has a thickness of 10 μm or more, and 20 μm or less.

10. The self-adhesive film according to claim 1, wherein the adhesive layer has a thickness of 1 μm or more and less than 30 μm, and the base layer has a thickness of 5 μm or more, and less than 100 μm.

11. The self-adhesive film according to claim 1, wherein the release layer contains a propylene-ethylene block copolymer.

12. The self-adhesive film according to claim 2, wherein the polyolefin-based elastomer is a copolymer of polypropylene and an ethylene-propylene rubber, and the adhesive layer has a thickness of 2 μm or more, and 5 μm or less.

13. A roll of the self-adhesive film according to claim 1, wherein the self-adhesive film has a width of 450 mm or more, and a length of 300 m or more.
